(19) United States
(12) Patent Application Publication
(10) Pub. No.: US 2017/0075431 A1
(43) Pub. Date: Mar. 16, 2017

(54) Customizable Software Keyboard Layouts and Accessory View

(71) Applicant: Vahagn Nurijanyan, North York (CA)

(72) Inventor: Vahagn Nurijanyan, North York (CA)

(21) Appl. No.: 14/850,903

(22) Filed: Sep. 10, 2015

(51) Int. Cl. G06F 3/023; G06F 3/02; G06F 3/0488

(52) U.S. Cl. CPC G06F 3/0237; G06F 3/04886; G06F 3/0219; G06F 3/04845

(57) ABSTRACT

Virtual input devices open new opportunities for rapid text input. The keyboard layouts and accessory views defined here learn and become more customized literally after each tap of a key. Keyboard layouts also can be customized by assigning any set of characters or words in any order to the layout keys. One of the weaknesses of nowadays software keyboards is lack of more suggested words on suggestion panel and frequent switch between letter and symbol layouts during the typing process. Here introduced Suggestions Bar and Symbols Bar solve these problems. Besides the Suggestions Bar appears only if it has words to suggest. Suggestions Bar makes possible to remove junk words directly from the Bar, and it can introduce only suggested words' suffixes to have more suggestions on the Bar at a time. The Suggestions Bar can be software accessory not only for software keyboards but also for physical ones.

### 1. FIELD

Physical keyboard is computer hardware with the keys to control computer or input characters. Mouse or trackpad is computer hardware that allows to tap virtual keys on the screen to control or interact with the computer. Software/virtual keyboard is software component having interface with virtual keys that allows a user to input characters or control computer by tapping the keys. Usually virtual keyboard can be operated with multiple input devices, like touchscreen, mouse, trackpad, etc. Accessory view is additional software extension of physical or software keyboard to expand and make the functionality more efficient.

### 2. BACKGROUND

Keyboards are necessary parts of computer systems to interact with. Software keyboards replaced the physical ones with the popularity of touchscreen computer systems. Mobile devices like smartphones and tablets are operating mainly with virtual keyboards, which replace physical ones. Virtual keyboards and their accessories like bars with some functional keys or predicted words are more flexible than physical ones and their functionality can be extended just beyond replacement of physical ones and they also can be used as accessories for physical keyboards.

Before iOS 8 user could delete accumulated predictive words' database, basically starting to accumulate the predictions from scratch. But user didn't and don't have ability to delete individual or selected words from the database.

Recently Android and iOS devices implemented Force Touch or 3D Touch kind of press applied to touchscreens or trackpads, what also can enforce the keyboards.

### 3. SUMMARY

This invention pertains to improve/extend design and functionality of the keyboard, making text input experience more efficient, generic and rapid. It defines customizable layouts, Predictive Keys and space input methods for the keyboards and software accessories for rapid and convenient text input. Accessory View may be customized with Symbols Bar, Assignment Panel accessory views for software keyboards and Suggestions Bar accessory views for both, physical and software keyboards. Here also is defined the way of space input without tapping Space key.

### 4. DEFINITIONS AND BRIEF DESCRIPTION OF THE DRAWINGS

Keyboard described herein relates to virtual or software keyboard for touchscreen computers, tablets and smartphones, otherwise it is used physical keyboard term. The following terms are described for detailed understanding of the description provided herein. The keyboard's interface consists of Input View and Accessory View which contains Accessory Bar; Symbols Bar; Suggestions Bar or Assignment Panel. Input View has one or more layouts, a layout at a time. The keyboard represented in drawings has six layouts: Small Letters, Capital Letters, Numbers, Symbols, Additional Small Letters and Additional Capital Letters. Each layout also contains Space and Return key, backspace key and if it has more than one layout, they also contain key(s) for layout switch.

Reference is now made to FIGS. 1A, 1B, 1C and 1D, where are demonstrated Capital Letters, Small Letters, Symbols layouts and Accessory Bar, Symbols Bar, Suggestions Bar, Assignment Panel Accessory Views respectively and Predictive Keys for Empty (defined below), ‘A’, New Line Current Characters (defined below) respectively.

In FIG. 1A layout is Capital Letters, Accessory View contains Accessory Bar and Current Character is an Empty.

In FIG. 1B layout is Small Letters, Accessory View contains Symbols Bar and Current Character is ‘A’.

In FIG. 1C layout is Small Letters, Accessory View contains Suggestions Bar and Current Character is ‘A’ again.

In FIG. 1D layout is Symbols, Accessory View contains Assignment Panel and Current Character is a New Line.

FIGS. 2A and 2B represent keyboard interface before and after tapping Small Letters layout key respectively: in FIG. 2A layout is Capital Letters, after tapping Small Letters layout key (9-th key of the last row) layout switches to Small Letters one (FIG. 2B) and previous (Small Letters) layout key transforms to Return key.

FIGS. 3A and 3B demonstrate keyboard interface before and after inserting ‘n’ character respectively. In FIG. 3A Current Character is ‘a’ and in FIG. 3B Current Character is ‘n’. They also represent Suggestions Bar.

FIGS. 4A, 4B, 4C, 4D, 4E, 4F and 4G demonstrate a method of using backspace for selecting then deleting or just selecting a text. They also represent Symbols Bar. FIG. 4A is the state before pressing backspace key, FIG. 4B is the state after pressing and keeping pressed backspace key, FIGS. 4C, 4D and 4E are the states of keeping pressed backspace key longer than in the previous one, FIG. 4 F is the moment after releasing backspace key by up-inside event of the key and FIG. 4G is the moment if backspace key would be released by up-outside event of the key.

FIGS. 5A and 5B demonstrate pressed Space key after either short and long or lightly and harder presses respectively, and FIG. 5C demonstrates the moment after the key being released after one of those presses. FIGS. 5A and 5B demonstrate Space key's popup key artwork after either short and long or lightly and harder presses respectively, with its' changed background color when either short or lightly press transfers to/becomes the either long or harder one respectively.

FIGS. 6A, 6B and 6C demonstrate pressed ‘e’ key after either short, long and long long or lightly, harder and long harder presses respectively, and FIG. 6D demonstrates the moment after the key being released after one of those presses. FIGS. 6A, 6B and 6C demonstrate ‘e’ key's popup key artwork after either short, long and long long or lightly, harder and long harder presses respectively, with its' changed background color when either short press transforms to the long one, then to the long long one or lightly press transforms to the harder one, then to the long harder one respectively.

### 5. DETAILED DESCRIPTION OF THE INVENTION

### 5.1. Predictive Keys

Predictive Keys are for faster input and it utilizes the fact that each language consists of specific pair of graphemes to be written. So, if pair of grapheme happens once/frequently, there is a big probability soon it will happen again in same or different context.

Current Character is a character touched to the cursor from the left/right, if text input direction is from the left/right to the right/left respectively. In particular Current Character can be a Space or New Line. If on the left/right of the cursor there isn't any character, the current character is considered to be an Empty. Inserted character or last character of inserted characters/word becomes Current Character.

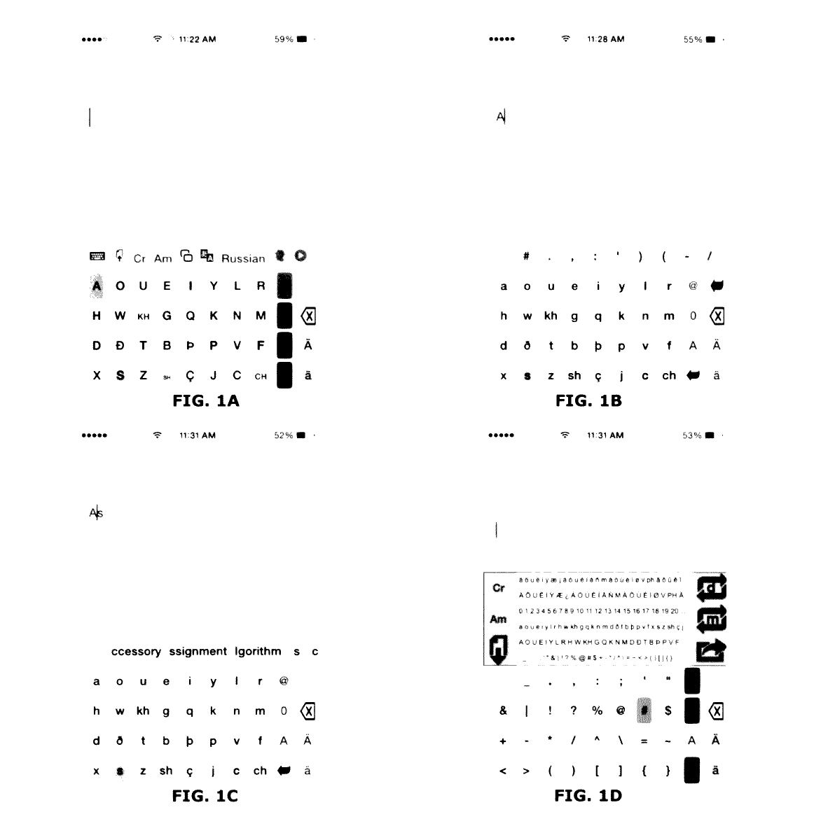

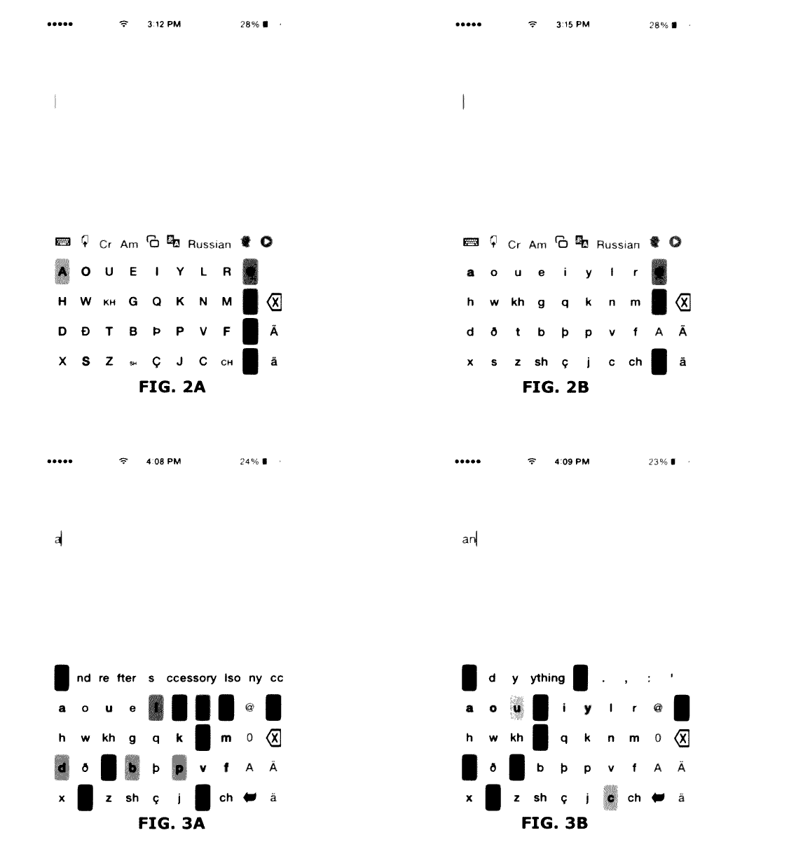

Each character, including Space, New Line and an Empty one, has own Predictive Table to be used when the character becomes the Current one. Predictive Table for each character contains statistics of happenings or inserting of all characters (Space and New Line but not an Empty included) after a character and statistics of happenings or tapping of all layout keys after a character. This statistics for Current Character can be represented via keyboard interface or layout. For example, each keyboard key's background colors intensity can represent happening/inserting after Current Character a character assigned to the key or in other words key's background color's intensity can represent probability of tapping the key for the Current Character. For example in FIG. 2A ‘U’, ‘E’ and Space characters/keys were not used frequently after an Empty Current Character, but ‘O’, ‘S’ and ‘F’ were used frequently and ‘A’, Return and Small Letters layout were used more frequently. And it doesn't matter what character is touched to the cursor from the right/left, if text input direction is from the left/right respectively. For example in the FIG. 1B and FIG. 1C Current Character is the same (‘A’) and in FIG. 1B on the right of the cursor is an Empty, in the FIG. 1C it is ‘s’ but keyboard keys' intensity are the same in both cases (appropriate keys of both figures have the same background intensity). If the title character of a key is never inserted after Current Character or the title consists of more than one character, its' background stays uncolored or with null intensity.

If inserted text is a character, during insertion it will be added to the table of Current Character and after insertion it will be on the left/right from the cursor (if typing direction is from the left/right respectively) and will become the Current one. If inserted text is a word (title of the key can be sequence of characters or the word can be inserted from Suggestions Bar defined below), in the beginning of insertion its' first character will be added to the Table of the Current Character, then word's each next character will be added to the Table of the previous character and at the end of insertion it will be on the left/right from the cursor (if typing direction is from the left/right respectively) and insertion's last character will become the Current one.

Automatic layout switch doesn't make any changes in Predictive Tables, but manual one does. Tapping a layout key doesn't change Current Character and keyboard interface continues to represent the same Predictive Table (FIGS. 2A and 2B represent the same predictive table of an Empty Current Character for Capital Letters (FIG. 2A) and Small Letters (FIG. 2B) layouts). It just increases priority of new (tapped) layout key (Small Letters layout key in FIGS. 2A and 2B) for Current Character (an Empty character in FIGS. 2A and 2B) but the key replaces with the Return key moved from the old or previous layout key (Capital Letters layout key in FIG. 2A). And the previous layout key's background gets null intensity for Current Character and it will stay with the null intensity meanwhile only layout keys are tapped: cursor position stays unchanged (in FIGS. 2A and 2B cursor isn't moved). Indeed, it doesn't have to have intense background color because user usually doesn't need to use that layout key to go back to the previous layout. The rest layout keys' background intensities (including Return key even if it is moved): their title characters' priority for the Current Character stay unchanged.

Deleting characters, on the contrary, make reverse changes in the Predictive Tables. For example, in the FIG. 3A Current Character is ‘a’, then after typing ‘n’ Current Character becomes ‘n’ (FIG. 3B), but after deleting ‘n’ using backspace button the keyboard interface will exactly look like as it is in FIG. 3A: Predictive Table for ‘a’ is exactly the same before inserting ‘n’ and after deleting ‘n’: Inserting ‘n’ increases priority of ‘n’ character for the ‘a’ Current Character Table, but deleting ‘n’ does opposite in the Table: decreases priority of ‘n’ for the ‘a’.

### 5.2 Symbols Bar

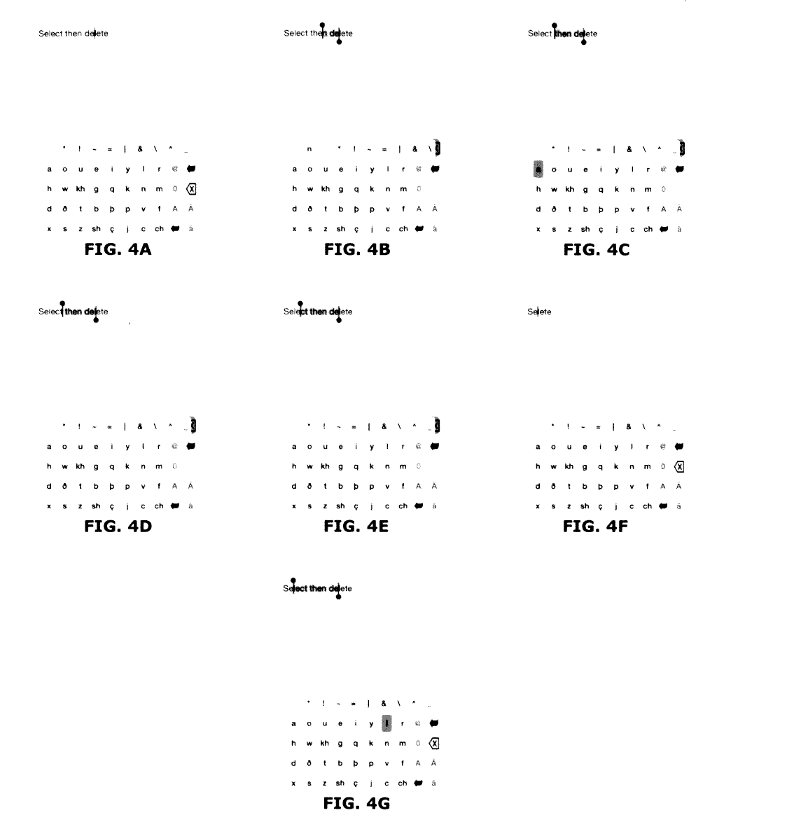

Accessory Bar can be manually switched into Symbols Bar (FIGS. 1B, 4A, 4B, 4C, 4D, 4E, 4F and 4G) containing symbol/punctuation keys, optionally being arranged according to their usage: the most or last used ones moved to the beginning, what is important for smartphones having short Bar . . . Promoted symbols/punctuations are previously inserted ones from (Symbols) layout; Suggestions Bar symbols (see below) or Symbols Bar itself. The first (and last) key in the Bar may be always a Space.

Switch between Accessory Bar and Symbols Bar is manual. For example, it can be done by keeping pressed Space/Return key (upper right key of Input View) to switch between Space and Return (it is Space in FIG. 1A and Return in FIG. 1B). When at the moment of key release it is Space, Accessory View contains either Accessory Bar or Suggestions Bar (if Suggestions Bar is full, it occupies Accessory View, and when it becomes empty Accessory Bar replaces it), and when at the moment of release it is Return key, Accessory View contains either Symbols Bar or Suggestions Bar (if Suggestions Bar is full, it occupies Accessory View, and when it becomes empty Symbols Bar will replace it). It is Ok to replace Space with Return in this manner because in the case of the Return Accessory View contains either Symbols or Suggestions Bar and both may have the Space key at their very beginning (and end).

### 5.3. Suggestions Bar

Accumulative Suggestions/Predictions Database is language independent and fully or partially consists of inputted words: all or some of the words of the database are inserted/used by the user: they are familiar to the user. Suggestions Bar may contain Space key in it's beginning and the sequence of suggested words, arranged according to their usage. And the words are separated from each other with tiny space or tiny something else to contain/show as many words as possible. It may also have the Space key at the end if there is empty space left on the Bar.

Suggestions Bar appears only if it has words to suggest, else its' place can be taken by another accessory: Accessory View replaces Accessory Bar/Symbols Bar with Suggestions Bar automatically, when there are predicted or suggested words for the current context (FIGS. 1C and 3A, 3B). Switch between Suggestions Bar and Accessory/Symbols Bar is automatic, which means Accessory View contains Suggestions Bar when it isn't empty, else: when Suggestions Bar is/becomes empty, Accessory View contains/shows either Accessory Bar or Symbols Bar. Suggestions Bar is always empty when Current Character is Space or New Line (FIG. 4C), in particular it happens after inserting Space or New Line character automatically or tapping Space or Return key.

Words are accumulating into the database via inserting Space or New Line character automatically or tapping Space or Return key after the word having two or more none space characters (when Current Character is the last character of the word having two or more none space characters). So, Suggestions Database accumulates inserted words (sequences of two or more characters, Space and New Line excluded) after inserting Space or New Line character after the words or after tapping Return key. It adds every two or more character length word to the Suggestions Database or if a word is already there, it increases priority of the word (to be shown on the Bar). Inserting first none Space or none New Line character (after a Space or New Line) brings suggested words beginning with that character to the Bar, then after each new none Space or none New Line character that offer of suggested words becomes more specific and narrow, and soon, when there is not any suggestions, Suggestions Bar disappears.

Suggestions Bar shows suggested or predicted words from the Database arranged according to their priority. If the word already exists in Suggestions Database, in particular if it was previously typed or inserted from Suggestions Bar, doing it again increases word's priority (probability to be required) in the Database and next time that word can have higher priority: it will appear more on the left on Suggestions Bar and can be closer to the beginning of the Bar. This is important for smartphones having short Bar, also user begins scanning the words from the beginning of the Bar and frequently used words will be found and be tapped earlier . . . . Words are separated with tiny space, and the longer is the bar (phone in landscape mode or it is tablet), more words it can contain.

If Suggestions Database initially has not accumulated (prebuilt) words, their priority can be the same as well as different (according to their statistical usage probability).

Optionally Suggestions Bar doesn't show inserted part of the words and contains/shows only suggested parts of the words (FIGS. 1C and 3A, 3B). Suggested words are represented on the Bar only by their suffix because prefix is already inserted or it is on the left/right from the cursor (for from the left/right to the right/left text input direction). Prefix isn't represented on Suggestions Bar (it is missing in suggested words) because it is already known. This makes possible to introduce more suggested words on the Bar, and a user can glance or find and tap the word faster.

If Suggestions Bar shows whole words, tapping (pushing then releasing) suggested word replaces the word's prefix in the text, else (if it shows suggested part of the words) touching and releasing appends to the word's prefix in the text. For example, in the FIG. 3B tapping and releasing ‘ything’ will append it to already inserted ‘an’ prefix of the word and ‘anything’ will be on the left of cursor (‘anything’ will be the current word in the text).

If after situating suggested words the Bar still has a space, it fills either with prolonged Space key or with symbol/punctuation keys, optionally being arranged according to their usage, previously inserted not as word prefixes: the most or last used ones at the beginning (FIG. 3B). This is important for smartphones having short Bar . . . Promoted symbols/punctuations are previously inserted ones from (Symbols) layout if symbols were not inserted as prefix; from Symbols Bar if symbols were not inserted as prefix or from Suggestions Bar symbols itself (which are only symbols inserted not as prefix for sure . . . ).

Word can be removed from the Bar and deleted from the Suggestions Database via touching (by finger on touchscreen or by mouse/trackpad pointer) and dragging it out from the Suggestions Bar.

If Suggestions Bar becomes empty (if there is no any suggested word (left)), what can happen after inserting a character or deleting a word and happens always after inserting Space or New Lane (tapping the Spaces or Return key), Suggestions Bar disappears and Accessory Bar/Symbols Bar appears.

Suggestions Bar keeps together (groups) and arranges alphabetically the words having the same priority, and the group of words having higher priority comes first. It also has an option to arrange the words by length (first come short ones) if their priority (probability to be the next inserted word) is the same: if they belong to the same group. It makes possible to have more visible words on Suggestions Bar, but the usefulness for their usage becomes less (usage of short words has less efficiency: saves less time to be inserted via Suggestions Bar than doing that via the layout of the keyboard).

Usually tapping the word inserts a Space automatically and Suggestions Bar disappears but Suggestions Bar also has the option not to insert a Space after a word automatically. So, usage of Suggestions Bar not always means it will disappear: it will stay if in the Database there is a word with the prefix of inserted word. That means after tapping/using a word the Database still can have suggestion(s) and Suggestions Bar can stay, making possible to use Suggestions Bar more than one time uninterruptedly. Inserted word from Suggestions Bar can be a prefix of another, longer word, then can continue to insert the rest (suffix) of the word via the layout or even again via Suggestions Bar, then after tapping a Space or Return key that longer word will be added to the database (or if it was already there, its' priority will grow). So, it is possible to use the Bar few times continuously or uninterruptedly. For example, after tapping a word ‘data’ Suggestions Bar can still have the word ‘database’ and after tapping the word ‘database’ Suggestions Bar can still have the word ‘databases’, etc. This is convenience for languages of none Latin families having a lot of suffixes for a word.

Here defined Suggestions Bar can be embedded in iOS or Android virtual keyboard or cloud based text processors (Google docs etc.) or computer based text processing software (Word, Pages, etc.) or computer OSs (Macintosh, Windows, etc.) to be used as an accessory for physical keyboard via mouse/trackpad pointer to touch to insert or drug out the words.

### 5.4. Assignment Panel

Assignment Panel is for customizing keyboard layouts by assigning any characters to the layout keys. Accessory View containing/showing Accessory Bar manually can be switched into Assignment Panel containing current, default or edited and ready to apply sequence of characters for the key titles of all layouts (FIG. 1D). The panel includes text fields: a text filled for each layout, where character/characters (words) are separated from each other by space. Character/characters (words) are in text fields, each character(s) or word for a title of key.

Keyboards usually have more than one layout. For example, the keyboard represented in the Figures have 6 layouts: Capital Letters, Small Letters, Numbers, Symbols, Additional Capital Letters and Additional Small Letters. Button on the Accessory View replaces Accessory View with the Assignment Panel, consisting of Text fields: a text filled per layout and buttons to bring default layouts, reset current layouts from the memory, save in the memory (and assign) edited layouts making them current ones, dismiss Assignment Panel and go back to Accessory Bar, etc.

### 5.5 Selector Backspace Key

Here is defined backspace key of the keyboard which can be used as a selector (FIGS. 4A-4G). Pushing It selects text (character by character or word by word) in backward direction instead of deleting it until to be released inside. The selected text can be deleted after releasing by up-inside event of backspace key (FIG. 4F), else (when releasing event is up-outside because touched finger is moved out of the boundaries of backspace key to be released) the text just remains selected (FIG. 4G).

5.6 Automatically Insert Space after Inserted Symbol

Symbol inserted from Symbols layout; Symbols Bar or Suggestions Bar also automatically inserts a Space.

5.7 Methods to Insert Space or Skip Accumulating Words into Suggestions Database Via Long or Harder Presses of the Keys

Lightly, harder and long harder kind of presses are defined only for virtual and physical keyboards or trackpads with 3D Touch or Force Touch support but short, long and long long kind of presses are defined for virtual and physical keyboards or trackpads with or without 3D Touch or Force Touch support. So, if virtual or physical keyboard has 3D Touch or Force Touch support, it can simultaneously deliver methods with both kind of pressing events defined below. Its' default set of presses to apply can be {short, long and long long}, which is similar with {lightly short, lightly long and lightly long long} and after having harder press it can cancel to apply that set and automatically can switch to work with the {lightly, harder and long harder} set of presses.

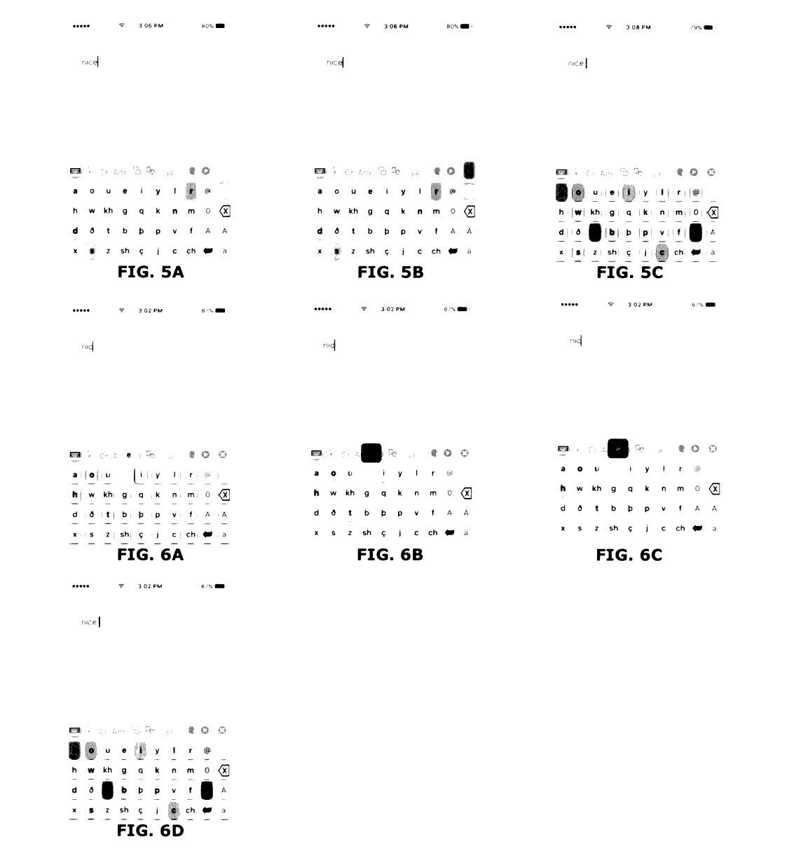

Words can be avoided to be added to Suggestions Database via either long or harder press of Space or Return key to insert Space (or New Line) character without accumulating current word to the Database. Indicator of either long or harder press of Space or Return key must appear on the keyboard interface to inform user either long or harder press. For example, it can be change of background color of pressed key's popup key artwork, as it is demonstrated in FIGS. 5A and 5B. Release of Space or Return key after both, either short and long or lightly and harder presses will insert just a Space or New Line or nothing (if Return key is pressed for textfield) (FIG. 5C), but releasing the key after either short or lightly press (FIG. 5A), also the ‘nice’ word (the word before the space) will be added to predictions database or if the word is already there, its' priority will be increased (the database will be altered) and releasing the key after either long or harder press (FIG. 5B) the ‘nice’ word (the word before the space) will not be added to predictions database or if the word is already there, its' priority will not be increased (the database will not be “touched” or altered). This way (optionally using either long or harder press of Space or Return key) user can control which words to add to Suggestions Database (either long or harder press will skip processing the Database).

If the pressed key of the keyboard is neither Space nor Return key, it also inserts Space character after either long or harder press. The indicator of either long or harder press on the keyboard interface must appear to inform user either long or harder press. For example, it can be change of background color of pressed key's popup key artwork, as it is demonstrated in FIG. 6B. Optionally, after either long long or long harder press, the indicator of either long long or long harder press on the keyboard interface must appear to inform user about either long long or long harder press. For example, it can be change of background color of pressed key's popup key artwork second time, as it is demonstrated in FIG. 6C. Releasing the key after either short or lightly press (FIG. 6A) just character (‘e’) will be inserted, but releasing it after either long or harder press (FIG. 6B), automatically the space also will be inserted (‘e’ then ‘ ’ will be inserted) and optionally also the ‘nice’ word (the word before the space) will be accumulated to Suggestions Database (predictions database) or if the word is already there, its' priority will be increased (the database will be altered) and optionally releasing it after either long long or long harder press, when indicator is changed second time, (FIG. 6C) again, automatically the space also will be inserted (‘e’ then ‘ ’ will be inserted) but the current word (‘nice’) will not be processed for the database: the word will not be accumulated to the database or if the word is already there, its' priority will not be increased (the database will not be “touched” or altered). So, the only difference between releasing after either long or harder press and after either long long or long harder press is that after either long or harder press (FIG. 6B) optionally the word before the space (‘nice’) will be added to predictions database or if the word is already there, its' priority will be increased (the database will be altered) but for optional either long long or long harder press (FIG. 6C) it will be skipped (database will not be altered). This way (optionally using either long long or long harder press of neither Space nor Return key) user can control which words to add to Suggestions Database (either long long or long harder press will skip processing the Database).

These methods of inserting Space character via none Space keys or controlling which words to add to or prioritize in Suggestions Database via either long and long long or harder and long harder presses are also true regarding pressing the word containing keys of Suggestions Bar (considering them as neither Space nor Return keys too) or pressing appropriate (Space/Return or neither Space nor Return) keys of physical keyboard.

What is claimed is:

1. Herein defined Predictive Keys of the keyboard interface for character input (Space or New Line included) and layout switch to be tapped after Current Character (Space, New Line and Empty included), highlighted according Predictive Table for the Current Character containing probability of the keys to be tapped next/after Current Character or on current position of the cursor.

2. Predictive Keys of claim 1, managing Predictive Tables of Current Characters during inserting character or sequence of characters; tapping layout key or Suggestions Bar word, comprising in the beginning of insertion inserted first character will be added to the Table of the Current Character, then word's each next character will be added to the Table of the previous one character and at the end of insertion inserted one will be on the left/right from the cursor (if text input direction is from the left/right respectively) and word's last character will become the Current one.

3. Predictive Keys of claim 1, further comprising tapping layout switching keys: meanwhile tapped keys are layout keys, the priority of tapped layout for the Current Character (registered in Current Character's Predictive Table) increases, but background of previously tapped layout keys' intensity becomes and stays null for the Current Character.

4. Predictive Keys of claim 1, further comprising deleting characters, on the contrary, make reverse changes in Predictive Tables, decreasing the priority of deleted characters for the Current ones.

5. Symbols Bar which replaces Accessory Bar on Accessory View and optionally has Space key at the very beginning (and at the end if there is empty space left) and fills with the sequence of symbol/punctuation keys, optionally arranged according to their usage: the most or last used ones at the beginning.

6. Symbols Bar of claim 5, further comprising manual switch between Accessory Bar and Symbols Bar in the manner described in Descriptions or can be designated button for that purpose on Accessory Bar or Input View.

7. Suggestions Bar with multiple or any quantity of words on it, arranged by their priority (probability to be used) and distanced not far from each other, comprising embedding it in text processing software or smartphone/tablet operational system or computer operational system to be used (the words to be tapped) in conjunction with virtual/physical keyboard.

8. Suggestions Bar of claim 7, further comprising replacing Accessory Bar/Symbols Bar automatically when it becomes filled in the manner of defined in Descriptions: Suggestions Bar occupies Accessory View, replacing Accessory/Symbols Bar when there are suggestions, else, in particular when Current Character is a Space or New Line (particularly when Space or New Line is inserted), Accessory/Symbols Bar appears again. It may have Space key at the very beginning.

9. Suggestions Bar of claim 7, further comprising offering as many words as possible because it skips inserted part of the words to contain/show only suggested parts of the words. In other words contains/shows only suffix (suggested part of the words) because prefix (inserted part of the words) is already represented in the text.

10. Suggestions Bar of claim 7, further comprising if it has left empty space at the end of Suggestions Bar (if it has not enough suggested words/word suffixes to fill the Bar) it fills either with prolonged Space key or with the sequence of not prefix symbol/punctuation keys, optionally arranged according to their usage: the most or last used ones at the beginning and previously inserted not as word prefix symbols/punctuations from the (Symbols) layout; Symbols Bar or Suggestions Bar itself (symbols inserted from Suggestions Bar never are word prefix).

11. Suggestions Bar of claim 7, further comprising deleting a word from the Suggestions Bar and Suggestions Database via dragging it out from the Suggestions Bar: the words can be drugged out (to be deleted) via the touch or mouse/trackpad pointer.

12. Suggestions Bar of claim 7, further comprising grouping together and optionally arranging by length the words having the same priority, the groups with higher priority in the beginning.

13. Suggestions Bar of claim 7, further comprising not inserting a space automatically after a word inserted from the Bar.

14. Assignment Panel, comprising assigning any sequence of characters or words to the keys of layouts of the keyboard. A text filled for each layout, where characters or words are separated from each other by space and represent title of appropriate keys of a layout. Each text field contains sequence of characters or words: a character(s) or word for a key title.

15. Assignment Panel of claim 14, further comprising Accessory Bar has a button manually to replace itself with Assignment Panel to assign any sequence of characters or words to the layouts of the keyboard. The panel consists of a button to bring default layouts, a button to reset text fields with current layouts from the memory, a button to save edited layouts in the memory as current layouts.

16. The method of using layout's backspace key to select then delete/just select chunk of text via pressing and releasing the key in/out of borders of the key respectively.

17. The method of automatically inserting Space character after each inserted symbol.

18. The methods of granting additional functionality to keys of virtual or physical keyboard or Suggestions Bar (where each key represents a word), besides their main functionality (the keys' main functionality is to insert characters or words assigned to them and representing via their title): releasing them after either long or harder press, comprising to neither Space nor Return keys of virtual or physical keyboard interface or keys of Suggestions bar to be released after either long or harder press to insert also Space character afterwords, or the method of granting additional functionality to Space or Return keys of virtual or physical keyboard interface (besides their main functionality to insert Space, New Line do Search or something else (Return key)): releasing them after either long or harder press to avoid/skip adding, sending or processing current word into Suggestions Database. Indicator of either long or harder press must appear or be provided on the keyboard interface to inform user transformation from either short or lightly press state to the either long or harder press state of the key, to indicate the time to be released. For example, the indicator can be change of background color of pressed key's popup key artwork.

19. The method of granting additional functionality to neither Space nor Return keys of virtual or physical keyboard interface or keys of Suggestions Bar of claim 18, further considering that releasing after either long or harder press is already reserved for the key's title and Space input and sending the word to Suggestions Database, comprising second additional functionality (besides inserting title of the keys and Space character afterwords) the method of skipping to accumulate current word to Suggestions Database: releasing neither Space nor Return key after either long long or long harder press (when the Space also will be inserted after the input of the word's suffix consisting of the title of pressed key of virtual or physical keyboard or Suggestions Bar), to avoid/skip adding, sending or processing current word into Suggestions Database. Indicator of either long long or long harder press must appear or be provided on the keyboard interface to inform user transformation from either long or harder press state to either long long or long harder press state of the key, to indicate the time to be released. For example, the indicator can be change of background color of pressed key's popup key artwork.
